(19) United States
(12) Patent Application Publication
(10) Pub. No.: US 2014/0129819 A1
(43) Pub. Date: May 8, 2014

(54) CLOUD CLUSTER SYSTEM AND BOOT DEPLOYMENT METHOD FOR THE SAME

(71) Applicant: DELTA ELECTRONICS, INC., Taoyuan County (TW)

(72) Inventors: Wen-Min HUANG, Taoyuan County (TW); Jui-Tsung HUNG, Taoyuan County (TW); Pa HSUAN, Taoyuan County (TW)

(73) Assignee: DELTA ELECTRONICS, INC., Taoyuan County (TW)

(21) Appl. No.: 14/041,430

(22) Filed: Sep. 30, 2013

(30) Foreign Application Priority Data
Nov. 2, 2012 (TW) 101140633

(51) Int. Cl. G06F 9/44

(52) U.S. Cl. CPC G06F 9/4413
USPC 713/2

(57) ABSTRACT

A cloud cluster system and a boot deployment method for the same are disclosed, wherein the cloud cluster system comprises a boot server, a management server, a system storage pool and at least one host. After the host is powered on, the host executes a network boot procedure according to a netboot policy. Next, the host connects to the system storage pool for accessing the corresponding root file system, and downloads the golden image from the boot server in order to complete the network boot procedure. After booted, the host is deployed by the management server. The management server enables the corresponding content of the host according to configurations thus the deployed host acting as the corresponding role in a cloud cluster system.

### BACKGROUND OF THE INVENTION

1. Field of the Invention

The present invention relates to a cloud cluster system, in particulate further relates to cloud cluster system and the boot deployment method used by the cloud cluster system, which are capable of booting hosts fast, and enabling the role of hosts without instructing the host to re-download the golden image or re-install operating system.

2. Description of Related Art

Generally speaking, the procedures to build a cloud cluster system are complicated which are challenges to administrators.

For example, when a new host is added to the cloud cluster system, a proper IP address and host name are assigned to the host. When the host uses the IP address and the host name to connect to the internet, the host is required to download a boot file (such as an operating system). When the file is downloaded, the installation process is performed on the host. In addition to providing the corresponding boot profiles to the host according to the acting role of the host after powering on, the corresponding deployment are performed on the host for installing the applications required by the role in the host according to the acting role of the host upon the installation is completed on the host.

The above procedures are implemented by different servers and the servers are operated by administrators to assure the whole building process is correct. It is a great challenge to administrators when there are too many hosts.

Further, the above are required procedures to complete when adding physical hosts to a cloud cluster system. When the cloud cluster system demands to add one or more virtual hosts on the physical host, the whole cloud cluster system is more complicated and more difficult to manage by the administrators.

### SUMMARY OF THE INVENTION

The objective of the present invention is to provide a cloud cluster system and a boot deployment method such that it is convenient to the administrators to add new hosts in a cloud cluster system, and further the administrators are allowed to change the role of the host after the host is deployed.

In order to achieve the above, the present invention discloses a cloud cluster system comprising a boot server, a management server, a system storage pool and at least one host. When the host is powered on, a network boot procedure is performed according to a netboot policy. Next, the host connects to the system storage pool for accessing the corresponding root file system and downloading the golden image from the boot server for completing the network boot procedure. After booted, the host accepts deployment performed by the management server. The management server enables corresponding content in the host according to configurations thus the deployed host acts as the corresponding role in cloud cluster system.

In contrast with the related art, the present invention provides an advantage that the host is required to download and execute the golden image for completing booting without installing the whole complete operating system after executing the network boot procedure. It is efficient by saving the time for powering the host and adding the host to the cloud cluster system.

Also, the administrators are allowed to configure the management server according to actual requirements. Then the management server deploys the host after booting according to configurations by the administrators, whereby the deployed host acts directly the required role in the system. When the administrators desire to change the role of the host, the administrators re-configure the management server, and then the management server re-deploys the host according to the latest configurations. The time to be back online is greatly reduced because the host does not need to re-download the golden image and does not need to install an operating system.

Further, the cloud cluster system of the present invention has a system storage pool, wherein the root file system in the system storage pool is used by the host for connecting to the network. When the host is booted and deployed, the data related to the system are saved in the system storage pool instead of the hard drive of the host. Thus, after the host is damaged, a back-up host is provided and connects to the system storage pool; the host is rapidly restored and added to the cloud cluster system.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a system architecture diagram of a preferred embodiment according to the present invention;

FIG. 2 is a rack schematic diagram of the cloud datacenter of a preferred embodiment according to the present invention;

FIG. 3 is a system block diagram of a preferred embodiment according to the present invention;

FIG. 4 is a golden image generating flowchart of a preferred embodiment according to the present invention;

FIG. 5 is a boot flowchart of a preferred embodiment according to the present invention;

FIG. 6 is a deployment flowchart of a preferred embodiment according to the present invention;

FIG. 7 is a system block diagram of another preferred embodiment according to the present invention;

FIG. 8 is a virtual host generating flowchart of a preferred embodiment according to the present invention;

FIG. 9 is a system block diagram of the other preferred embodiment according to the present invention;

FIG. 10 is an assign flowchart of a preferred embodiment according to the present invention;

FIG. 11 is an assign flowchart of another preferred embodiment according to the present invention; and

FIG. 12 is a boot and deployment time diagram of a preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

The present invention provides a cloud cluster system (referred as the system in the following description), and boot deployment method used by the cloud cluster system. With the present invention, when a blank host is added to the system, the host is rapidly booted and deployed to be the role required by the system, such as a management node, a compute node, a storage node or a website node, and are not limited thereto. When an administrator desires to change the role of a host, the administrator directly changes the role of the host by deploying the host. The host is not required to re-install the operating system and applications required. Thus, the processing time required to add a host to the system is greatly reduced.

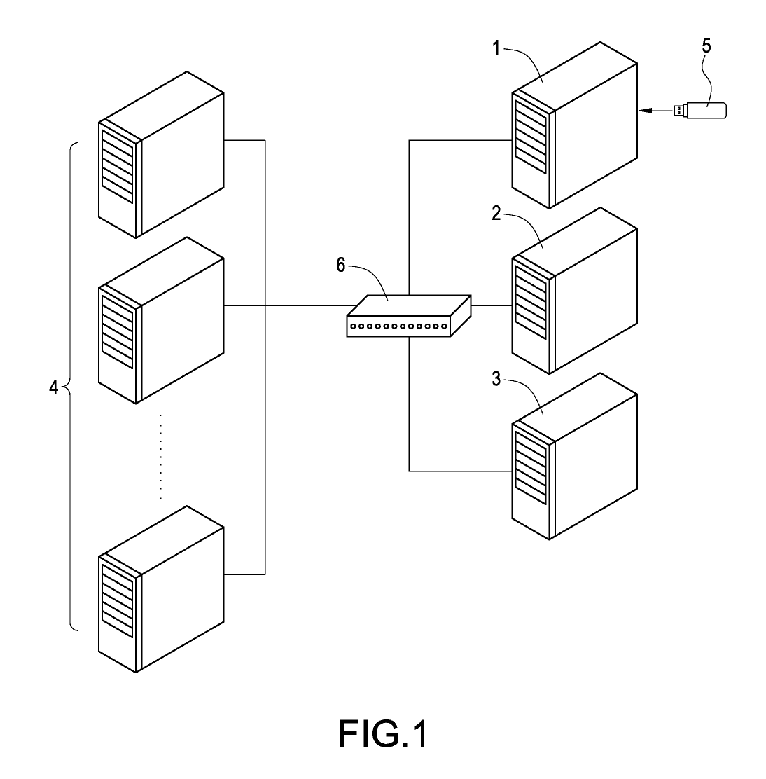

FIG. 1 is a system architecture diagram of a preferred embodiment according to the present invention. The system of the present invention comprises a boot server 1, a management server, a system storage pool 3 and at least one host 4. It should be noted that, when the host 4 is not added to the system, it is a blank host.

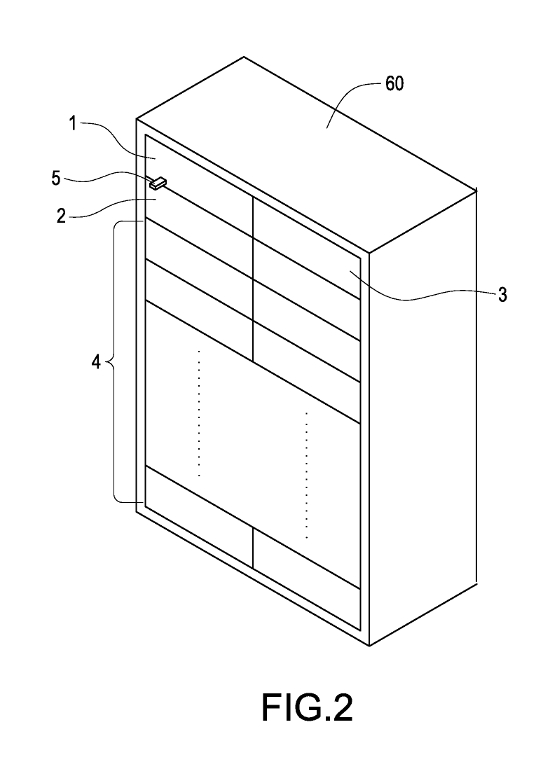

FIG. 2 is a rack schematic diagram of the cloud datacenter of a preferred embodiment according to the present invention. As shown in the diagram, the boot server 1, the management server 2, the system storage pool 3 and the host 4 are disposed on the same rack 60 in the cloud datacenter, interconnected by a switch 6 in the rack 60. Nonetheless, the above mentioned is one of the preferred embodiment of the present invention. The boot server 1, the management server 2, the system storage pool 3 and the host 4 respectively are disposed in different racks or different datacenter, and interconnected via a network, and are not limited thereto. Further, the system storage pool 3 is a large storage space integrated by a plurality of storage spaces (such as hard drive in many servers) in the system. The diagrams illustrate the present embodiment as a single server, but the system storage pool 3 is not limited to the embodiment as a single server.

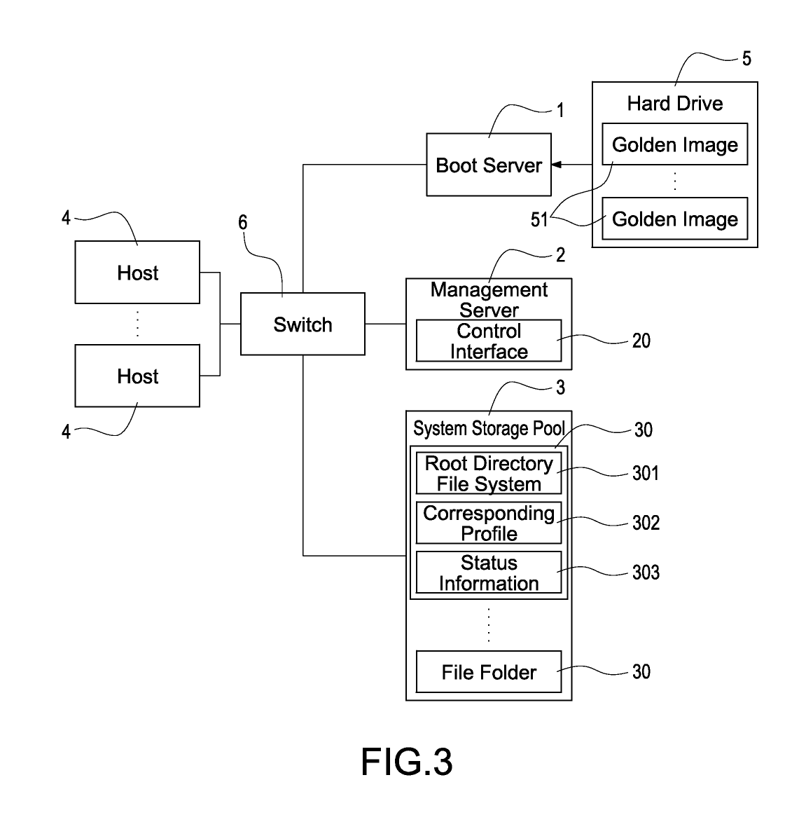

FIG. 3 is a system block diagram of a preferred embodiment according to the present invention. After the host 4 is powered on, the boot server 1 immediately provides the host 4 a netboot policy, wherein the host 4 executes a network boot procedure according to the netboot policy, such as a Preboot eXecution Environment (PXE), but is not limited thereto.

The boot server 1 plugs in a hard drive 5 with the connection ports or external Serial Advanced Technology Attachment (e-SATA) connection ports via its connection port (not shown in the diagram), such as a Universal Serial Bus (USB) ports. Further in details, the hard drive is a plug and play portable storage device. The hard drive 5 is saved with at least one golden image 51. The golden image 51 comprises a complete operating system, and the content required by the roles in the system, such as applications, files, system configurations and system utilities, and are not limited thereto.

When the host 4 executes the network boot procedure to a particular step, the boot server 1 downloads and directly uses the golden image 51 to complete the whole network boot procedure. In other words, the system does not perform corresponding installation on the host 4 by the acting role of the host after booting. Instead, all the required content of all roles are installed in the golden image 51 to provide to the host 4. Thus, the host 4 is not required to install a complete operating system, which effectively saves the booting time of the host 4.

The system storage pool 3 is constituted by a plurality of storage spaces in the system providing to the host 4 for saving the data. After the host 4 is powered on, the host 4 connects to the system storage pool 3 for using the space in the system storage pool 3. The system storage pool 3 has at least one root file system 301, when the host 4 connects to the system storage pool 3, the host 4 accesses and uses the root file system 301. Thus, the data related to the system and executed by the host 4 is all saved in the system storage pool 3, instead of saving in the hard drive of the host 4 (not shown in the diagram). Further in details, the host 4 connects to the system storage pool 3 via network mounting and taking the system storage pool 3 as a local hard drive of the host 4, and uses the space in the system storage pool 3.

Further in details, the system storage pool 3 is divided into a plurality of file folders 30. Each file folder 30 respectively is provided to different host 4. A host 4 connects one of the plurality of file folders 30 in the system storage pool 3 for accessing the root file system 301 in the file folder 30 and using the file folder 30. Thus, the system storage pool 3 simultaneously provides to several hosts 4, and the data of each host 4 do not interfere each other and the data leak issue is eliminated.

The greatest advantage of using the system storage pool 3 is that all data related to the host 4 and the system are saved in the corresponding data folder 30. After the host 4 is damaged, a back-up host is added and the same network boot procedure is executed on the back-up host. The back-up host connects to the same data folder 30 in the system storage pool 3, downloads and uses the golden image 51 for restoring the host 4 on back-up host.

It should be noted that, all the hosts 4 in the system downloads and uses the same golden image 51. These hosts 4 have exactly the same content after booting without role differences. Thus, after the host 4 completes booting, the host 4 has to connect to the management server 2 for registering, whereby the host 4 is deployed by the management server 2 thus the deployed host 4 directly acts the corresponding role in the system.

As shown in the diagram, the management server 2 has a control interface 20, the control interface 20 is a web-based user interface (UI) or command line interface (CLI) provided to the administrators for performing operations. The administrators configure required roles on the host 4 via operating on the control interface 20, whereby the control interface 20 generates a corresponding profile 302 according to the configured content of the administrators, wherein the profile 302 records the required content of the role.

When the administrators complete configuration, the management server 2 initiates a deployment procedure, i.e., the management server 2 enters automatically into the host 4, and enable the corresponding content of the role in the golden image 51 used by the host 4 according to the profile 302. Thus, the host 4 is deployed by the management server 2 and acts the role as configured by the administrators.

As mentioned above, all the required content of all roles in the system are in the golden image 51 downloaded and used by the host 4. The deployment performed by the management server 2 is to enable the corresponding content of the role configured for the host 4 by the administrators, and disable the unrequited content by the role. Nonetheless, the host 4 still keeps other content required by other roles, and the disabled content are not deleted. In other words, when the administrators desire to change the role of the host 4, the administrators re-configure, the control interface 20 generates new profile 302, the management server 2 disables other content and enables the corresponding content according to the new profile 302 when performing deployment. Accordingly, the host 4 can be easily deployed to be other roles.

It should be noted that in order to rapidly restore the host 4 when the host 4 is damaged. After the profile 302 is generated, the management server 2 saves the profile 302 in the file folder 30 in the system storage pool 3 the host 4 connects to and uses. Thus, when a back-up host is initiated and connects to the same file folder 30, the management server 2 deploys according to the profile 302 in the file folder 30 without reconfiguration by the administrators.

After the host 4 registers at the management server 2, the management server 2 is informed that the host 4 completes booting. Accordingly, the system can monitor the operating status such as traffic, throughput, CPU usage, temperature or humidity etc. of the host 4 via the management server 2. The management server 2 generates the status information 303 according to the operating status of the host 4, and periodically saves the status information 303 in the file folder 30 in the system storage pool 3 the host 4 connects to and uses. Further, the management server 2 display the above profile 302 and the status information 303 with texts or graphics via the control interface 20, whereby the administrators check on various information of the host 4 via the control interface 20 and perform better management on the system accordingly.

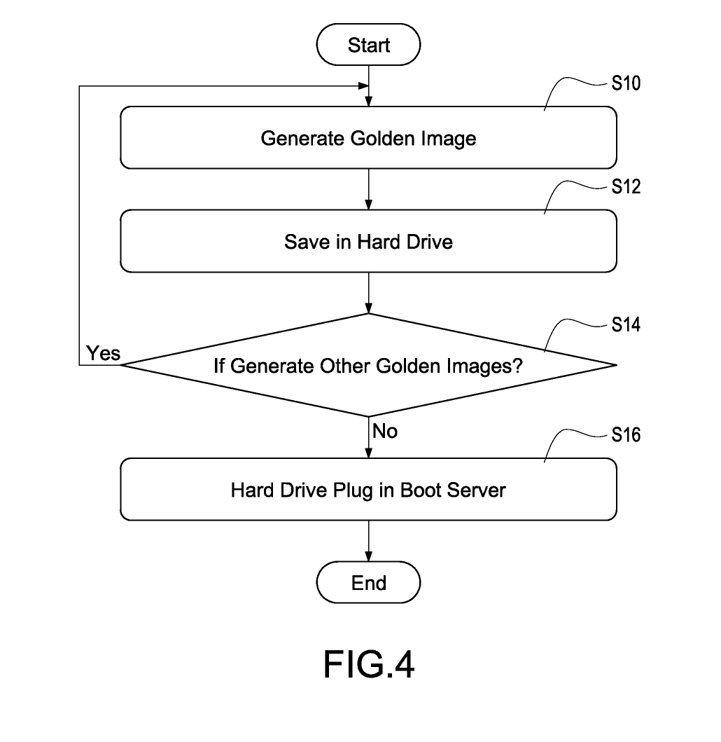

FIG. 4 is a golden image generating flowchart of a preferred embodiment according to the present invention. First, the administrators install operating systems required by the system, and various content required by various roles via additional servers (not shown in the diagram). Further, these operating systems and content are used for generating the golden image 51 (step S10). After the golden image 51 is generated, the golden image 51 is saved in the hard drive 5 (step S12). Next, determine if required to generate other golden images (step S14). If yes, re-execute the step S10˜the step S12 for generating and saving other images. If the golden image is generated, the hard drive 5 is plugged in to the boot server 1 (step S16).

There may be a plurality of golden images 51 in the hard drive 5 than only one golden image 51. The objective of the above steps is that the host 4 is allowed to simultaneously download a plurality of golden images 51, and uses corresponding golden image 51 according to the system requirements. Nonetheless, the above is provided as one of the preferred embodiment according to the present invention and is not limited thereto.

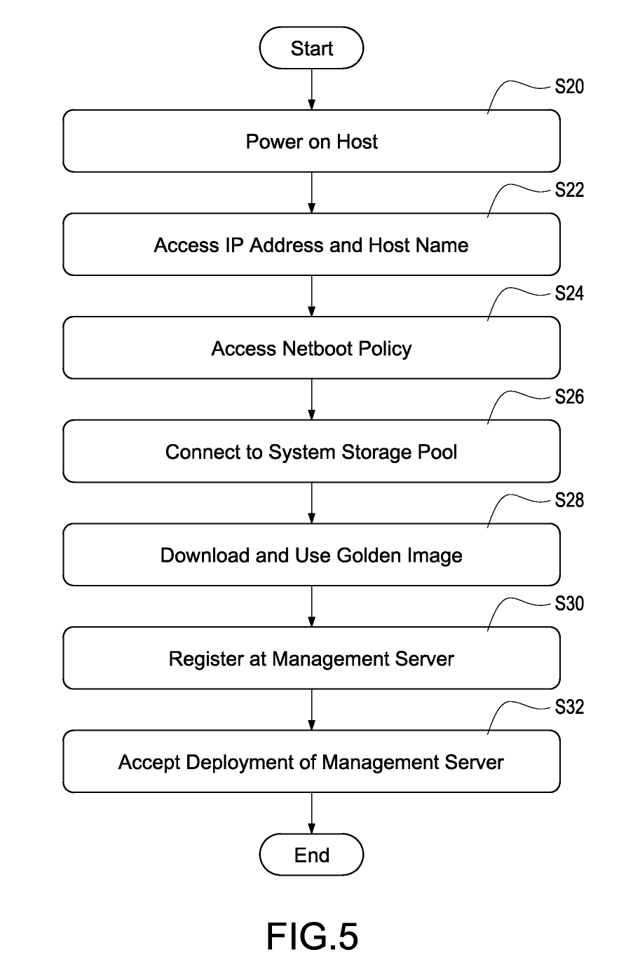

FIG. 5 is a boot flowchart of a preferred embodiment according to the present invention. When a blank host 4 is added to the system (for example plugged in a socket in the rack 60), it is connects to the boot server 1 via the switch 6, the management server 2 and the system storage pool 3. After the host 4 is added, the host 4 is powered on (step S20), wherein the administrators press a physical booting button (not shown in the diagram) on the host 4, or remotely control to power on the host 4 via Wake-On-LAN (WOL) and the method is not limited thereto.

After the host 4 is powered on, the host 4 first accesses an available IP address and an available host name (step S22). Next, the host 4 uses the IP address to connect to the boot server 1, and access the netboot policy via the boot server 1 (step S24). Thus, the host 4 executes the network boot procedure according to the IP address, the host name and the netboot policy. Next, the host 4 connects to the system storage pool 3 and makes a request to connect to the system storage pool 3 (step S26) for accessing the root file system 301, and using the space of the system storage pool 3. Further in details, the host 4 connects to the corresponding file folders 30 of the system storage pool 3 for accessing the root file system 301 in the file folder 30, and using the space of the file folder 30.

After the host 4 accesses the root file system 301, the host 4 reconnects to the boot server 1 for downloading and using the golden image 51 in the boot server 1 in the hard drive 5 (step S28) and completes the network boot procedure. Lastly, after the host 4 completes booting, the host 4 registers at the management server 2 (step S30), to accept deployment by the management server 2 (step S32), and acts the required role of the system after the deployment is completed.

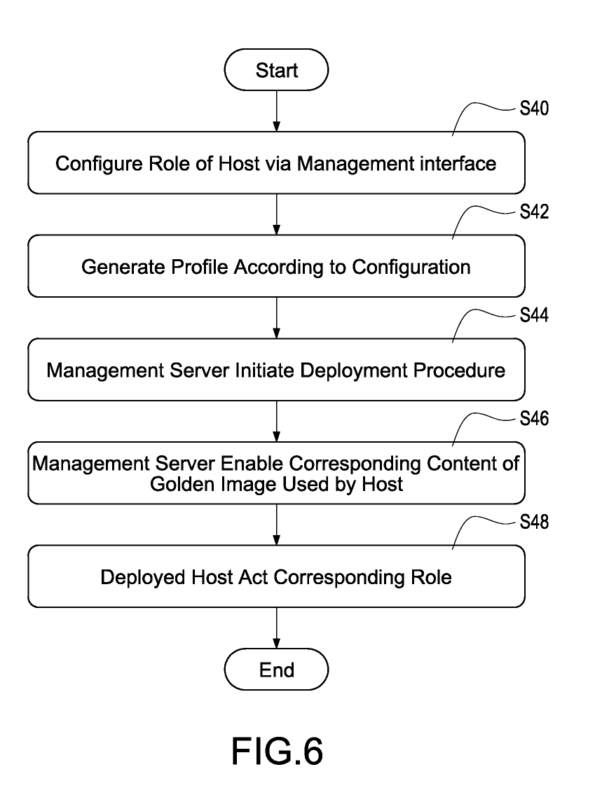

FIG. 6 is a deployment flowchart of a preferred embodiment according to the present invention. As mentioned previously, after a plurality of the hosts 4 complete booting, the plurality of the hosts 4 have the same content which is because the golden image 51 used by the hosts 4 comprise required content of all the roles in the system. Thus, in order to make the hosts 4 act specific roles in the system, the management server 2 has to further perform the deployment. First, the management server 2 has to provide the management interface 20. The management interface 20 accepts external operations by the administrators for configuring the required role for the host 4 (step S40).

Next, the control interface 20 generates the above profile 302 according to the configuration (step S42), wherein, the profile 302 records the required content of the role. After the configurations completes, the management server 2 initiates a deployment procedure (step S44). In the deployment procedure, the management server 2 enters the host 4 and enables the corresponding content of the role in the golden image 51 used by the host 4 according to the profile 302 (step S46). Thus, after the deployment, the host 4 acts the role configured by the administrators configurations (step S48). It should be noted that the golden image 51 may enable all the contents by default, the profile 302 records the unrequited contents of the role, and the management server 2 disable all the unrequited contents of the role in the golden image 51 used by the host 4 according to the profile 302. Nonetheless, the above embodiment is a preferred embodiment according to the present invention, and the scope is not limited thereto.

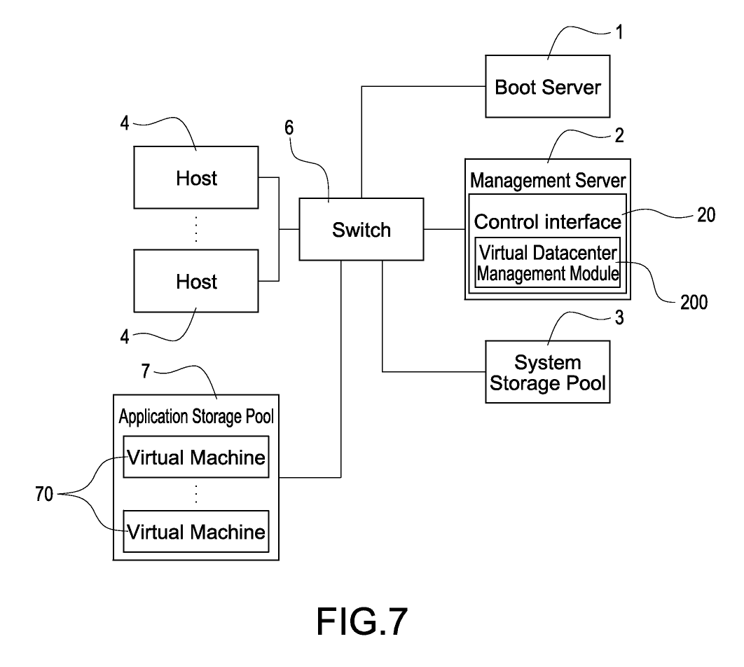

FIG. 7 is a system block diagram of another preferred embodiment according to the present invention. In the embodiment, the system further comprises an application storage pool 7 connecting to the host 4. Further in details, the application storage pool 7 connects to the switch 6 of the rack 60, and connects to the boot server 1 via the switch 6, the management server 2 and the host 4. The application storage pool 7 is a large storage space integrated by a plurality of storage spaces (the blank hard drives in multiple hosts 4). The diagrams of the present invention is exemplified as a single server for the conveniences of illustration, but the scope of the application storage pool 7 is not limited to the single server.

The difference from the system storage pool 3 lies in that the system storage pool 3 provides a fix space to the host 4 for saving the data of the host 4 related to the system. The application storage pool 7 provides larger and more flexible storage space to the host 4 thus the host 4 is allowed to generate and use various applications in the application storage pool 7.

In the embodiment, the control interface 20 is a physical the datacenter management module (PDCM) in the system used for controlling and managing all physical hosts in the system (such as the host 4). As shown in FIG. 7, the control interface 20 further has a virtual datacenter management module (VDCM) 200 for managing all the virtual hosts in the system.

The administrators control the control interface 20, and further use the virtual datacenter management module 200 of the control interface 20. The virtual datacenter management module 200 accepts external operations for instructing the host 4 to generate a virtual host 70 demanded by the system, and the generated virtual host 70 is saved in the application storage pool 7. The virtual host 70 is generated according to the golden image 51 used by the host 4. Thus, the system does not need to offer installation service of the operating systems and the applications for generating the virtual host 70.

The administrators easily control which host 4 generates the virtual host 70, how many virtual hosts 70 to generate, and which roles of the virtual host 70 to act on by operating on the virtual datacenter management module 200 according to the present invention. The present invention is extremely convenient to operate to the administrators.

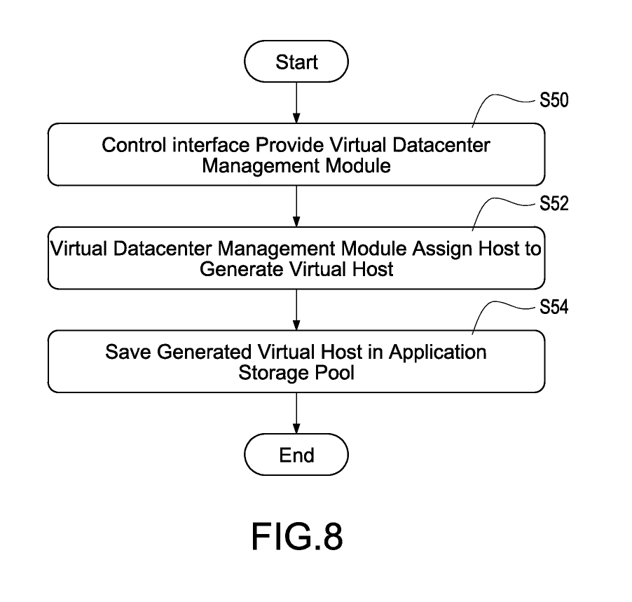

FIG. 8 is a virtual host generating flowchart of a preferred embodiment according to the present invention. As mentioned above, first, the control interface 20 of the management server 2 provides the virtual datacenter management module 200 (step S50). Next, the virtual datacenter management module 200 accepts external operations for instructing the host 4 to generate the virtual host 70 (step S52). The virtual host 70 generates the virtual host 70 according to the golden image 51 used by the host 4, and the generated virtual host 70 are saved in the application storage pool 7 (step S54). The application storage pool lis divided into multiple file folders respectively connects to different hosts 4, the connection/mount methods are the same with the system storage pool 3, which are not further explained in the description.

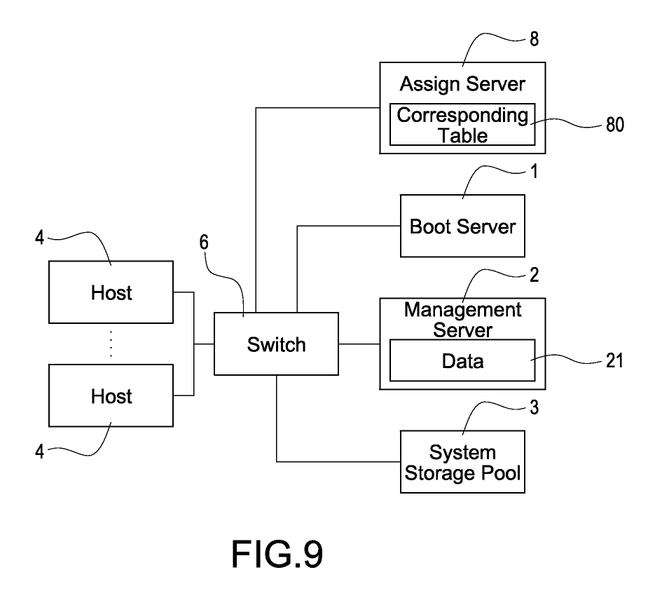

FIG. 9 is a system block diagram of the other preferred embodiment according to the present invention. As shown in the diagram, the system further comprises an assign server 8, connecting to the boot server 1, the management server 2, the system storage pool 3 and the host 4. In the embodiment, the assign server 8 is used for assigning, managing the IP addresses and the host names of all the hosts 4 in the system.

In the embodiment, the host 4 connects to the one of the port on the switch 6 (not shown in the diagram), and the assign server 8 connects to the switch 6. Thus, the host 4 connects to the assign server 8 via the switch 6 for accepting to the services of the assign server 8. The administrators configure the management server 2 in advance and assure the system topology the data 21 is saved in the management server 2. The assign server 8 connects to the management server 2, and accesses the topology data 21. Thus, the assign server 8 assigns an IP address and a host name in advance of each port on the switch 6. Thus, when the host 4 connects to one of the port on the switch 6, the host 4 makes a request to the assign server 8 for using the IP address and the host name assigned to the port according to the topology data 21.

It should be noted that, the assign server 8 can configure a proprietary IP address and host name for each port of each switch in the cloud datacenter according to the topology data 21. In the embodiment, the switch 6 serves as an example but the scope is not limited thereto.

In the step S22 in the FIG. 5, the host 4 connects to the assign server 8, the assign server 8 makes a request and the host 4 accesses and uses the assigned IP address and the assigned host name of the port the host 4 connects to after the request is permitted. Thus, the host 4 executes the network boot procedure via the IP address and the host name. Further in details, the assign server 8 generates a corresponding table 80 according to all the generated IP addresses and the host names. After the host 4 makes a request to the assign server 8, the assign server 8 inquires the corresponding table 80 for accessing the assigned IP address and the assigned host name of the port the host 4 connects to.

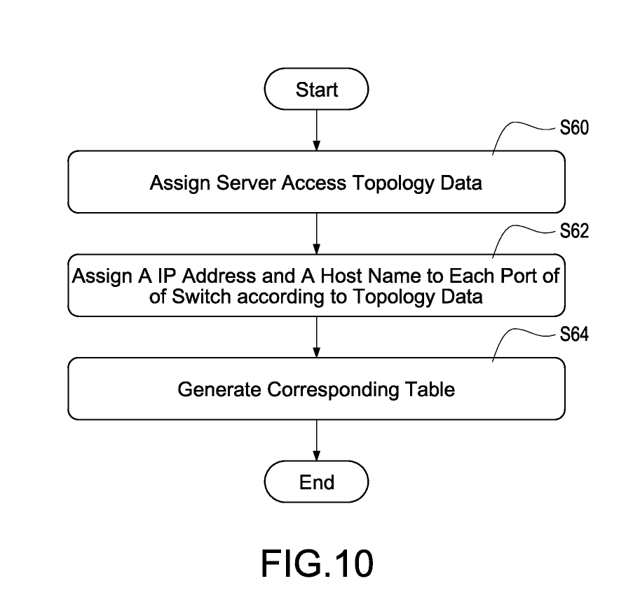

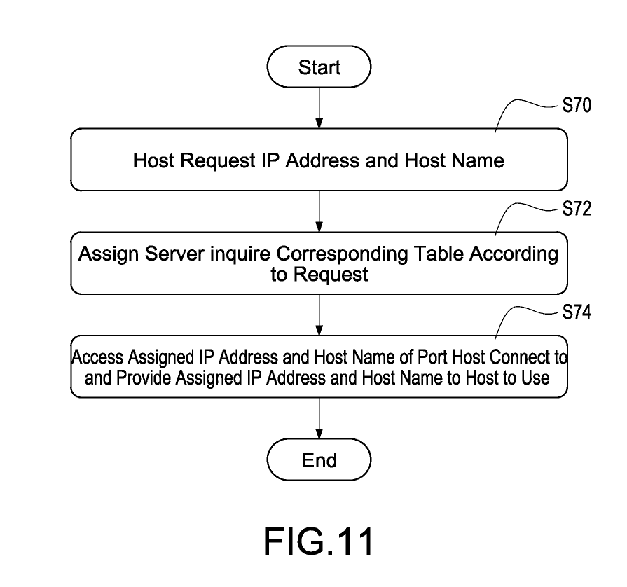

FIG. 10 and FIG. 11 are assign flowcharts of a preferred embodiment and another preferred embodiment according to the present invention. As shown in FIG. 10, before the system operation, the administrators have to configure the topology data 21 of the system, and save the topology data 21 of the system in the management server 2. Thus, after the assign server 8 is online, the management server 2 accesses the topology data 21 (step S60) and assigns an IP address and a host name to each port of the switch 6 according to the topology data 21 (step S62). Lastly, for the convenience of inquiring, the assign server 8 generates the corresponding table 80 and saves the corresponding table 80 in the assign server 8 according to the IP addresses and the host names (step S64).

As shown in FIG. 11, after the host 4 is powered on, and before the network boot procedure is executed, the host 4 has to make a request of an IP address and a host name to the assign server 8 (step S70). The assign server 8 receives the request and inquires the corresponding table 80 according to the request (step S72). Further, the assign server 8 accesses the assigned IP address and the assigned host name the port the host 4 connecting to according to the inquire results, and the IP address and the host name are provided to the host 4 to use (step S74). After the step S74, the host 4 uses the IP address and the host name for executing the network boot procedure.

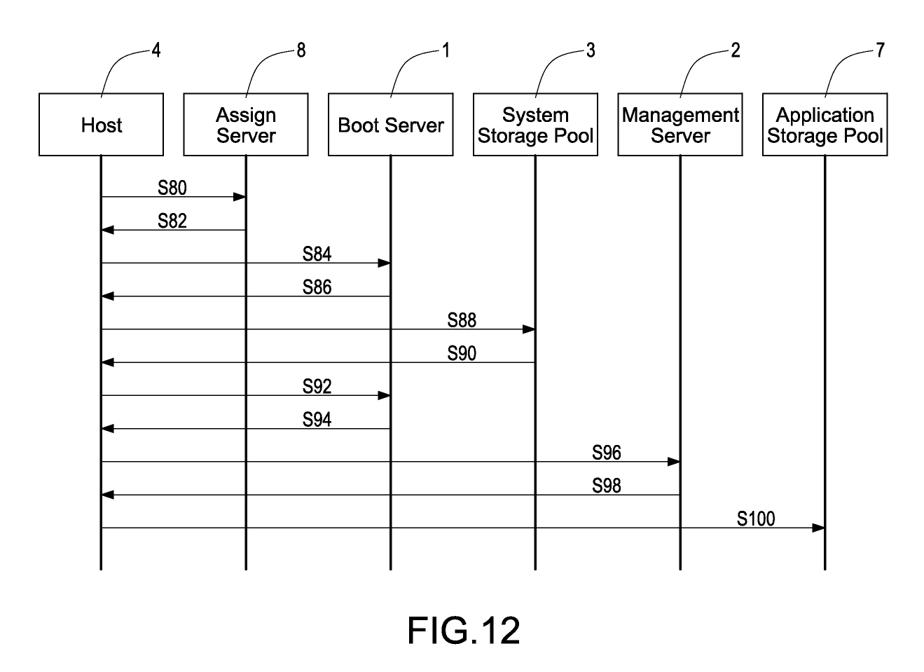

FIG. 12 is a boot and deployment time diagram of a preferred embodiment according to the present invention. As shown in the diagram, the components of the boot deployment method according to the present invention comprises the boot server 1, the management server 2, the system storage pool 3, the host 4, the application storage pool 7 and the assign server 8.

First, the host 4 is plugged in any socket in the rack 60, and connects to the switch for connecting to these components 1, 2, 3, 7, 8 in the system via the switch 6. After the host 4 is powered on, the host 4 makes a request on the assign server 8 (step S80). The assign server 8 receives the request, inquires the corresponding table 80, accesses an IP address and a host name available to the host 4, and reply the IP address and the host name to the host 4 (step S82). The host 4 accesses the IP address and the host name, and the host 4 makes a request of the netboot policy to the boot server 1 (step S84). The boot server 1 receives the request, and replies the netboot policy to the host 4(step S86). After the step S86, the host 4 executes the network boot procedure according to the IP address, the host name and the netboot policy.

Next, the host 4 connects to the system storage pool 3, and makes a request to connect to and use the system storage pool 3 (step S88). The system storage pool 3 receives the request, assigns a proprietary file folder 30 for the host 4, and reply to indicate location of a pointer of the file folder 30 to the host 4 (step S90). Thus, the host 4 connects to the proprietary file folder 30 of the host 4 in the system storage pool 3 according to the pointer, accesses the root file system 301 in the file folder 30 and uses the space of the file folder 30. After accessing the root file system 301, the host 4 reconnects to the boot server 1 and make a request to download the golden image 51 (step S92). After the boot server 1 permits the request, the host 4 downloads and uses the golden image 51 and further completes the whole network boot procedure (step S94).

After the host 4 completes booting, the host 4 registers at the management server 2 (step S96) to be monitored by the management server 2, and accepts the deployment by the management server 2 (step S98). The management server 2 deploys the host 4 according to the role configured by the administrators. After the step S98, the corresponding content of the role in the golden image 51 used by the host 4 is enabled. Further, the host 4 acts the role configured by administrators after the deployment. Lastly, when the administrators demand, the host 4 connects to the application storage pool 7, and generates the virtual host 70 to save in the application storage pool 7 according to instruction of the virtual datacenter management module 200.

After the host 4 is added to the system, the host 4 only needs to download the golden image 51 once, when the administrators desire to change the role of the host 4, the administrators enable/disable the content of the golden image 51 used by the host 4 to easily change the role of the host 4 via the management server 2, the host 4 does not need to re-download the golden image 51, and does not need to install additional operating systems or applications. Thus, the speed to build a cloud cluster system is made faster and easier.

Additionally, the host 4 connects to use the system storage pool 3 and save all the data related to the system in the system storage pool 3. Accordingly, when the host 4 fails, a bank-up host is provided to connect to the same file folder 30 in the system storage pool 3 to rapidly restore the host 4, which is convenient. Further, the administrators can easily instruct the host 4 to generate, delete, and move the virtual host 70 via the connection to the application storage pool 7, and operations with the virtual datacenter management module 200, which is advantageous to the whole cloud cluster system.

As the skilled person will appreciate, various changes and modifications can be made to the described embodiments. It is intended to include all such variations, modifications and equivalents which fall within the scope of the invention, as defined in the accompanying claims.

What is claimed is:

1. A cloud cluster system, comprising:
a boot server connecting to a hard drive with a golden image saved in the hard drive;
a management server connecting to the boot server;
a system storage pool connecting to the boot server and the management server, the system storage pool having a root file system; and
a host connecting to the boot server, the management server and the system storage pool, the host making a request of a netboot policy to the boot server after powered on and executing a network boot procedure according to the netboot policy, the host connecting to the system storage pool to access the root file system and use the space of the system storage pool, the host downloading and using the golden image from the boot server for completing the network boot procedure;
wherein, upon the host completes the network boot procedure, the host accepts a deployment operation of the management server thus the deployed host directly acts as a corresponding role in the cloud cluster system.

2. The cloud cluster system of claim 1, wherein the hard drive is a plug and play portable storage device.

3. The cloud cluster system of claim 1, wherein the golden image comprises a required content of all roles in the cloud cluster system, the management server has a control interface accepting external operations for configuring one of the roles of the host, the control interface generates a profile according to the configuration, the management server enables to the corresponding content of the corresponding role in the golden image used by the host thus the host to act the corresponding role according to the profile.

4. The cloud cluster system of claim 3, wherein the system storage pool is divided in to a plurality of file folders, each file folder respectively has the corresponding root file system, the host connects to one of the plurality of file folders in the system storage pool for accessing the root file system in the file folders, and using the space in the file folders.

5. The cloud cluster system of claim 4, wherein the management server saves the profile in the file folders of the system storage pool connected to and used by the host.

6. The cloud cluster system of claim 4, wherein the host registers at the management server, the management server monitors an operating status of the host to generate status information, the status information is saved in the file folders of the system storage pool connected and used by the host.

7. The cloud cluster system of claim 6, wherein the management server displays a profile of the host and the status information with texts or graphics via the control interface.

8. The cloud cluster system of claim 3, wherein further comprising an assign server, the host connects to the assign server via one of ports in a switch, the host makes a request of an IP address and a host name to the assign server, and uses the IP address and the host name for executing the network boot procedure.

9. The cloud cluster system of claim 8, wherein the topology data of the cloud cluster system is saved in the management server, the assign server assigns an IP address and a host name to each port on the switch according to the topology data, and generates a corresponding table according to the IP addresses and the host names, the host makes a request to the assign server, the assign server inquires a corresponding table for accessing the assigned IP address and the assigned host name of the port connected to the host, the assign server providing the assigned IP address and the assigned host name to the host to use.

10. The cloud cluster system of claim 3, further comprising an application storage pool, wherein the control interface further has a virtual datacenter management module (VDCM) for receiving external operations to instruct the host to generate a virtual host, and the data of the virtual host is saved in the application storage pool, wherein the virtual host is generated according to the golden image of the host.

11. A boot deployment method for a cloud cluster system, wherein the cloud cluster system comprising a boot server, a management server, a system storage pool and a host, and the boot deployment method comprising:
a) powering on the host;
b) the host making a request of a netboot policy to the boot server for executing a network boot procedure;
c) the host connecting to the system storage pool for accessing a root file system of the system storage pool and using the space of the system storage pool;
d) the host downloading a golden image from the boot server and using the golden image for completing the network boot procedure;
e) after the host completing the network boot procedure, the host registering at the management server; and
f) the host receiving deployment by the management server thus the deployed host directly acts as a corresponding role in the cloud cluster system.

12. The boot deployment method for a cloud cluster system of claim 11, wherein the boot server connects to a plug and play portable storage device, and the golden image is saved in the portable storage device.

13. The boot deployment method for a cloud cluster system of claim 11, wherein the golden image comprises a required content of all roles in the cloud cluster system, the management server has a control interface, and the step f comprising following steps:
f1) the control interface receiving external operations for configuring one of the roles on the host;
f2) generating a profile according to the configuration, wherein the profile records the content required by the corresponding role;
f3) the management server enabling the required content according to the corresponding role in the golden image used by the host according to the profile.

14. The boot deployment method of claim 13, wherein the system storage pool is divided in to a plurality of file folders, the corresponding root file system saves in each file folder respectively, the host connects to one of the plurality of file folders in the system storage pool for accessing the root file system in the file folders, and using the space in the file folders.

15. The boot deployment method of claim 14, wherein the cloud cluster system further comprises an assign server, the host connects to the assign server via one of the port of the switch, the topology data of the cloud cluster system is saved in the management server, and the method further comprises the following steps before the step a:
a01) the assign server assigning an IP address and a host name to each port on the switch according to the topology data; and
a02) generating a corresponding table according to the IP addresses and the host names.

16. The boot deployment method of claim 15, wherein the method further comprising following steps after the step a:
a1) the host making a request of an IP address and a host name to the assign server;
a2) the assign server inquiring the corresponding table according to the request of the host; and
a3) accessing the assigned IP address and the assigned host name of the port connected to the host and providing the assigned IP address and the assigned host name to the host to use.

17. The boot deployment method of claim 14, wherein the cloud cluster system further comprises an application storage pool connecting to the host, the control interface further has a virtual datacenter management module, and the boot deployment method further comprising following steps:
g) the virtual datacenter management module receiving external operations to instruct the host to generate a virtual host, wherein the virtual host is generated according to the golden image of the host; and
h) saving the data of the virtual host in the application storage pool.

18. A boot deployment method for a cloud cluster system, wherein the cloud cluster system comprises a boot server, a management server, a assign server, a application storage pool, a system storage pool and a host, and the boot deployment method comprising:
a) powering on the host;
b) the host accessing an IP address and a host name from the assign server;
c) the host making a request of a netboot policy to the boot server for executing a network boot procedure according to the IP address, the host name and the netboot policy;
d) the host connecting to the system storage pool for accessing a root file system of the system storage pool and using the space of the system storage pool;
e) the host downloading a golden image from the boot server and using the golden image for completing the network boot procedure, wherein the golden image comprises the required content of all roles in the cloud cluster system;
f) after the host completing the network boot procedure, the host registering at the management server;
g) the management server providing a control interface, the control interface receiving external operations for configuring one of the roles of the host;
h) the control interface generating a profile according to the configuration, wherein the profile records the content required by the role;
i) the management server enabling the required content according to the corresponding role in the golden image used by the host according to the profile thus the deployed host acts the corresponding role in the cloud cluster system;
j) the control interface providing a virtual datacenter management module;
k) the virtual datacenter management module receiving external operations to instruct the host to generate a virtual host, wherein the virtual host is generated according to the golden image of the host; and
l) saving the data of the virtual host the in the application storage pool.

19. The boot deployment method of claim 18, wherein the host connects to the assign server via one of the port of the switch, the topology data of the cloud cluster system is saved in the management server, the method further comprises following steps before the step a:
a01) the assign server assigning an IP address and a host name to each port on the switch according to the topology data; and
a02) generating a corresponding table according to the IP addresses and the host names.

20. The boot deployment method of claim 19, wherein the method further comprises the following steps after the step a:
a1) the host making a request of an IP address and a host name to the assign server;
a2) the assign server inquiring the corresponding table according to the request of the host; and
a3) accessing the assigned IP address and the assigned host name of the port connect to the host and providing the assigned IP address and the assigned host name to the host to use.
